(19) United States
(12) Patent Application Publication
(10) Pub. No.: US 2023/0035001 A1
(43) Pub. Date: Feb. 2, 2023

(54) Greeting Card with Pop-Up Lock

(71) Applicant: American Greetings Corporation, Cleveland, OH (US)

(72) Inventor: Charles Robert Kelly, Amherst, OH (US)

(21) Appl. No.: 17/386,972

(22) Filed: Jul. 28, 2021

(51) Int. Cl. G09F 1/06

(52) U.S. Cl. CPC G09F 1/06

(57) ABSTRACT

A greeting card with pop-up structure and a lock mechanism to maintain the greeting card and pop-up structure in an open or unfolded position without the use of locking tabs being used in conjunction with the pop-up structure.

### RELATED APPLICATIONS

There are no applications related to this application.

### FIELD OF THE INVENTION

This application is in the field of social expression products, and more specifically is directed to greeting cards having a novel pop-up lock which maintains the greeting card in an open or unfolded position.

### SUMMARY OF THE INVENTION

In one embodiment, the greeting card with pop-up lock of the present disclosure and related inventions includes a greeting card comprising a first greeting card panel and a second greeting card panel attached to the first greeting card panel along a fold line, a pop-up element attached to the greeting card, the pop-up element operative to move between a first or closed position wherein it is folded between the first and second greeting card panels and a second or open position wherein it is unfolded atop an inside surface of the first and second greeting card panels, and an arced perforated line or fold line which extends from a lower left section of the first greeting card panel to the lower right section of the second greeting card panel, wherein opening the greeting card and folding the greeting card along the perforated line or fold line maintains the greeting card and pop-up element in an second or open position.

In another embodiment, the greeting card with pop-up lock includes a greeting card comprising a first panel attached to a second panel along a fold line, the greeting card operative to move between a first or closed position wherein the first panel is folded over the fold line to lie atop the second panel, and a second or open position, wherein the first panel is unfolded over the fold line to lie adjacent the second panel, a pop-up element that opens when the greeting card moves from the second position to the first position and closes when the greeting card moves from the first position back to the second position and a lock element comprising a perforated or fold line which begins at a bottom left section of the first greeting card panel and ends at a bottom right section of the second greeting card panel creating an arced segment at the bottom of the greeting card beneath the perforated line or fold line, wherein moving the greeting card from the first or closed position to the second or open position and then folding the perforated line or fold line in a downward direction, maintains the greeting card and pop-up element in open positions.

And in still another embodiment, the greeting card with pop-up lock includes a greeting card having a first panel and a second panel and an arced fold line which bifurcates the greeting card into an upper portion which lies above the arced fold line and a lower portion which lies beneath the arced fold line, and a pop-up structure which is attached to an inside surface of the greeting card, the pop-up structure operative to move between a first or closed position wherein the pop-up structure is collapsed or folded and a second position wherein the pop-up structure is upright or unfolded, wherein folding the greeting card in a downward direction along the arced fold line maintains the pop-up structure in the second position wherein it is upright or unfolded.

### DESCRIPTION OF THE DRAWINGS

FIG. 1 is a perspective view of an open greeting card with pop-up structure and folded lock mechanism.

FIG. 2 is a perspective view of the greeting card of FIG. 1, in a closed position.

FIG. 3 is a perspective view of the greeting card of FIG. 1, in a partially open position.

FIG. 4 is a perspective view of the greeting card of FIG. 1, in an open position with unfolded lock mechanism.

FIG. 5 is a perspective view of the greeting card of FIG. 1 with arrows showing the direction of the lock mechanism being folded in a downward direction.

FIG. 6 is a front view of the greeting card of FIG. 1.

FIG. 7 is a right side view of the greeting card of FIG. 1.

### DETAILED DESCRIPTION OF PREFERRED AND ALTERNATE EMBODIMENTS

Many greeting cards having pop-up devices, specifically 180-degree pop-up devices, do not have a way to display the greeting card and pop-up element in an open or unfolded position as both panels of the greeting card, between which the pop-up element resides, cannot remain flat and in contact with a display surface. Other greeting cards with 180-degree pop-up elements have very intricate folds and flaps which operate in conjunction with the pop-up element to keep the pop-up element open or have means by which the pop-up element is removed from the greeting card in order to be maintained in an open or unfolded position. The greeting card with lock mechanism of the present disclosure and related inventions solves and simplifies this issue by creating a lock mechanism to maintain the greeting card and pop-up element in an open or unfolded position without the use of locking tabs being used in conjunction with the pop-up element.

The greeting card 100 of the present disclosure and related inventions includes a greeting card 10 and a 180-degree pop-up element 12. The greeting card 10 includes at least two greeting card panels, a first panel 10A connected to a second panel 10B along a first fold line F1. Each of the two greeting card panels 10A, 10B has an inside surface 10AI, 10BI and an outside surface 10AO, 10BO opposite the inside surface 10AI, 10BI.

A pop-up element 12 which includes various pop-up sections 12S that interlock to form the 180-degree pop-up element 12. At least one pop-up section 12S is attached to the inside surface of the first greeting card panel 10AI and at least one other pop-up section 12S is attached to the inside surface of the second greeting card panel 10BI.

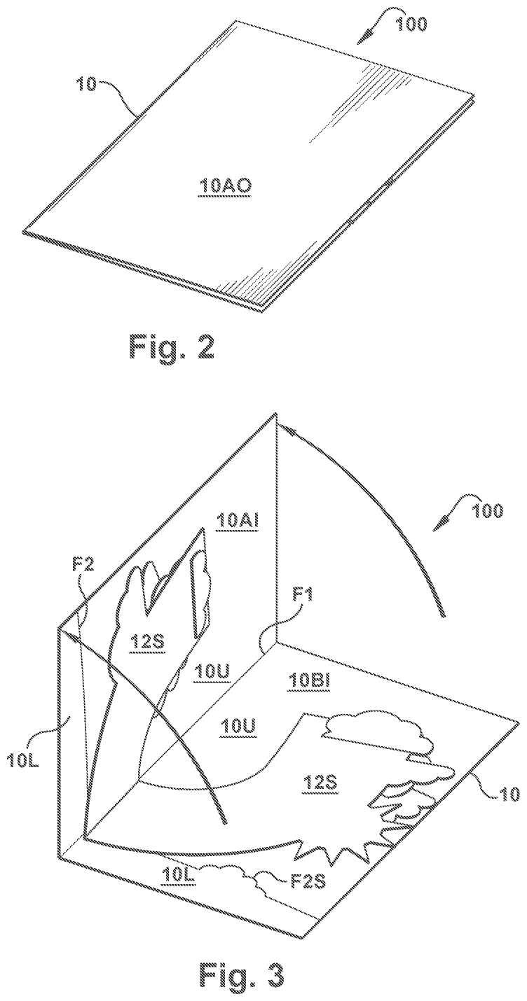

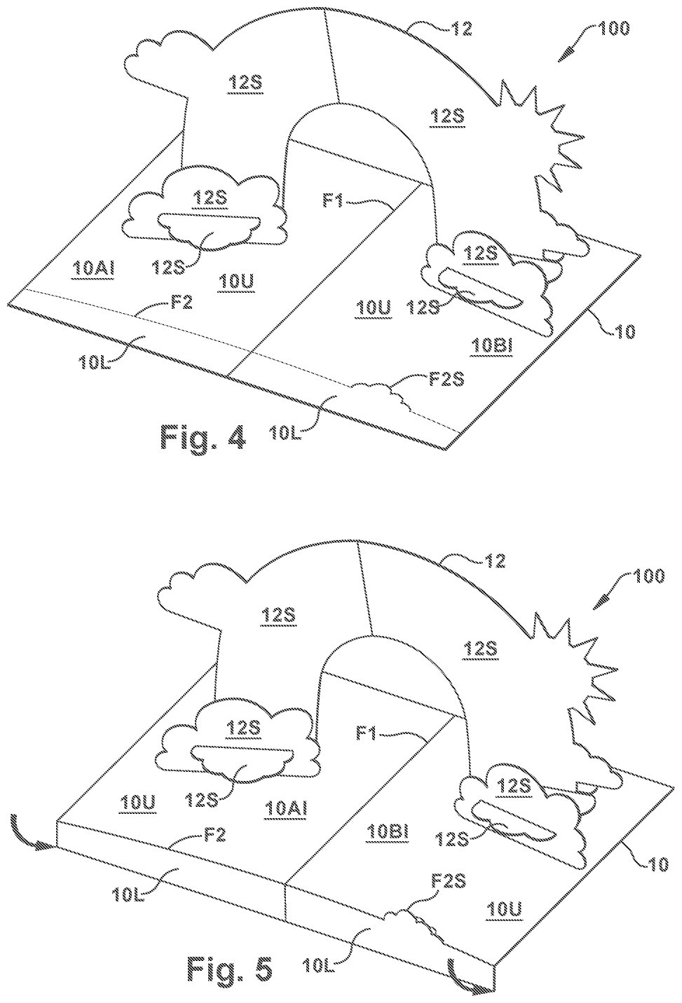

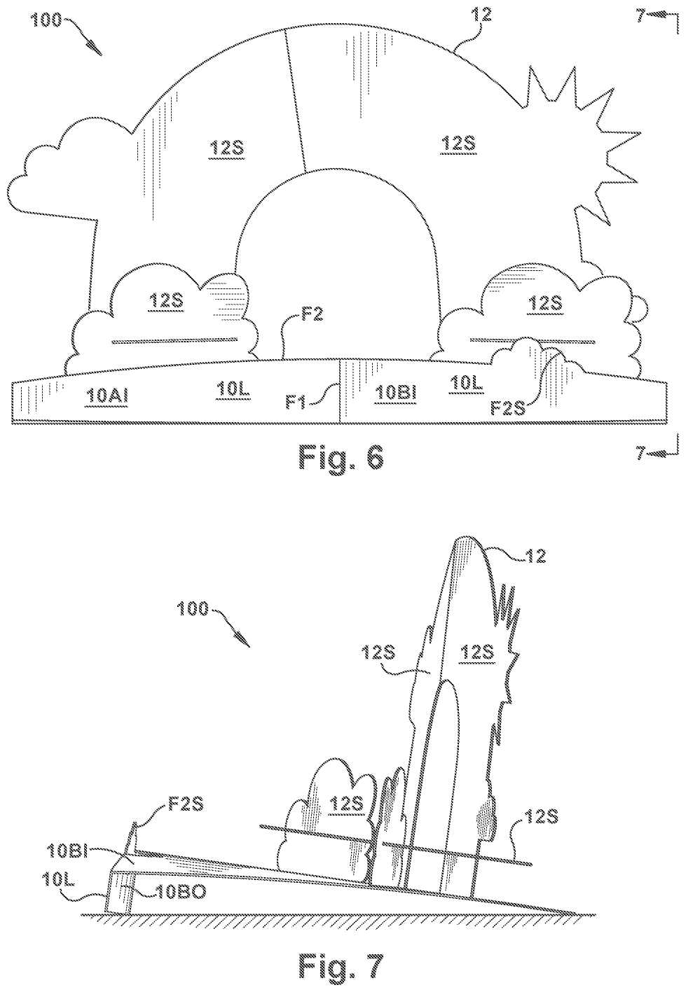

The greeting card 10 is in a closed position when the first panel 10A rotates along the first fold line F1 towards the second panel 10B to lie atop the second panel 10B wherein the inside surface of the first panel 10AI and the inside surface of the second panel 10BI are in direct contact or in a face-to-face orientation, as shown in FIG. 2. The greeting card 10 is opened by pivoting the first greeting card panel A1 backward about the first fold line F1 and away from the second greeting card panel 10B, such that the inside surface of the first greeting card panel 10AI and the inside surface of the second greeting card panel 10BI are no longer in direct contact or in a face-to-face orientation, as shown in FIG. 3.

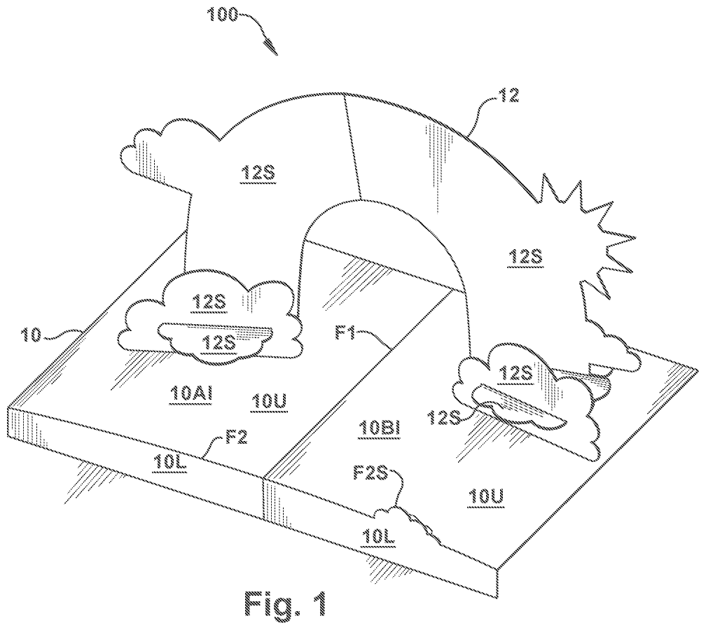

The pop-up element 12, which resides between the two greeting card panels 10A, 10B and which is in contact with the two greeting card panels 10A, 10B, is operative to move between a first position, where the sections or pieces 12S of the pop-up element 12 are folded together or collapsed into a substantially flat position between the two panels 10A, 10B of a closed greeting card 10 (see FIG. 2), and a second position were the sections or pieces 12S of the pop-up element 12 are unfolded or upright position between (atop) the two panels 10A, 10B of an open greeting card 10 (see FIG. 1, 4, 5). The pop-up element 12 opens and closes with the greeting card 20. The pop-up element 12 may contain any number of sections or pieces 12S that enable the pop-up element 12 to collapse and unfold into a 3-D shape or FIG. 12. The pop-up element 12 may be attached directly to the greeting card 10 or may be indirectly attached to the greeting card via a connection piece or panel. In one embodiment, the pop-up element 12 is attached at a first point to the first greeting card panel 10A and a second point to the second greeting card panel 10B. The pop-up element 12 is not able to be removed from within the panels of the greeting card 10. The sections or pieces 12S of the pop-up element 12 may combine to form any type of shape or figure, such as, for example, as shown in the Figures, a rainbow.

Once the greeting card 10 has been opened, the recipient may wish to display the greeting card 10 and pop-up 12 on a display surface by maintaining them in an open position. The two panels 10A, 10B of the greeting card 10 contain a second fold line F2 thereon arranged in an substantially horizontal arced position which spans from the lower left section of the first greeting card panel 10A over the first fold line F1 and on to the lower right section of the second greeting card panel 10B, which divides the greeting card 10 into a first or upper 10U section and a second or lower section 10L. The line is hereto referred to as a “fold” line, however, portions of or the entire line may be perforated. The second fold line F2 may be a full fold line, a full perforated line, or a combination of both. Folding the greeting card 10 downward (or towards a display surface upon which the greeting card is to be displayed) along the second fold line F2 creates a slight elevation of one end of the greeting card 10 with respect to the other end (see FIG. 7) and thereby maintaining the greeting card 10 and pop-up element 12 in an open position suitable for display. The second fold line F2 may be a simple line crossing from one side of the greeting card 10 to the other or it may contain segments F2S that correspond with or coordinate with the theme or aesthetic of the greeting card 10. For example, if the pop-up element 12 is a sky scene with a rainbow, the second fold line F2 may at one point have an segment F2S that follows a particular pattern so that when folded, resembles that of a cloud, as shown in FIGS. 1, 5, 7). This segment F2S would be perforated so that when the second fold line F2 (of which segment F2S is a part of) is folded in a downward direction (or toward a display surface therebeneath) the non-linear segment F2S would be detached along the perforated segment F2S from the greeting card to protrude upward and contribute to the aesthetic of the card design. While the second fold line F2 has been described as extending from the lower right section of the first greeting card panel 10A to the lower left section of the second greeting card panel 10B, it may alternatively extend from the upper right section of the first greeting card panel 10A to the upper left section of the second greeting card panel 10A.

While the object of the present disclosure and related inventions has been described herein as being of a particular size, shape, etc., other sizes and shapes of both the greeting card and pop-up element have been contemplated and are considered to be within the scope of the present invention. The pop-up element may contain any number of interlocking pieces and may take on any shape or form. The foregoing embodiments of the present invention have been presented for the purposes of illustration and description. These descriptions and embodiments are not intended to be exhaustive or to limit the invention to the precise form disclosed, and obviously many modifications and variations are possible in light of the above disclosure. The embodiments were chosen and described in order to best explain the principle of the invention and its practical applications to thereby enable others skilled in the art to best utilize the invention in its various embodiments and with various modifications as are suited to the particular use contemplated. It is intended that the invention be defined by the following claims.

1. A greeting card with pop-up comprising:
a greeting card comprising a first greeting card panel and a second greeting card panel attached to the first greeting card panel along a fold line;
a pop-up element attached to the greeting card, the pop-up element operative to move between a first or closed position wherein it is folded between the first and second greeting card panels and a second or open position wherein it is unfolded atop an inside surface of the first and second greeting card panels;
an arced fold line or arced perforated line which extends from a lower left section of the first greeting card panel to the lower right section of the second greeting card panel, creating a sub-panel along a bottom section of the greeting card;
wherein opening the greeting card and folding the greeting card along the arced fold line or arced perforated line in a downward direction, places the greeting card and sub-panel in a substantially perpendicular position with a lower edge of the sub-panel in contact with a flat surface which maintains the greeting card and pop-up element in an second or open position.

2. The greeting card of claim 1, wherein the pop-up element is attached to both the first and second greeting card panels.

3. The greeting card of claim 1, wherein the arced fold line or arced perforated line does not come into contact with the pop-up element.

4. The greeting card of claim 1, wherein unfolding the arced fold line or arced perforated line back to its original position and closing the greeting card moves the pop-up element from the second or open position back to the first or closed position.

5. The greeting card of claim 1, wherein the arced fold line or arced perforated line may contain ornate segments which when the arced fold line or arced perforated line is folded downward to maintain the greeting card and pop-up element in an open position, protrude upward from the inside surface of the greeting card.

6. The greeting card of claim 5, wherein the ornate segments of the arced fold line or arced perforated line are thematically coordinated with the pop-up element.

7. A greeting card with pop-up element comprising:
a greeting card comprising a first panel attached to a second panel along a fold line, the greeting card operative to move between a first or closed position wherein the first panel is folded over the fold line to lie atop the second panel, and a second or open position, wherein the first panel is unfolded over the fold line to lie adjacent the second panel;
a pop-up element attached to an inside surface of the greeting card that lies folded between the first and second greeting card panels when the greeting card is in the first or closed position and that unfolds into a 3D element when the greeting card moves from the first or closed position to the second or open position;
an arc-shaped fold line or arc-shaped perforated line that spans the width of the first and second greeting card panels;
wherein moving the greeting card from the first or closed position to the second or open position and folding the greeting card in a downward direction along the arc-shaped fold line or arc-shaped perforated line, maintains the greeting card in the second or open position between a lower edge of the greeting card and an upper edge of the greeting card.

8. The greeting card with pop-up element of claim 7, wherein the arced segment of the greeting card beneath the fold line or perforated line is substantially smaller than a remaining portion of the greeting card which lies above the fold line or perforated line.

9. The greeting card with pop-up element of claim 7, wherein folding the fold line or perforated line in a downward direction causes the arced segment of the greeting card beneath the fold line or perforated line to be angled with respect to the remaining portion of the greeting card at less than 180-degrees.

10. The greeting card with pop-up element of claim 7, wherein a portion of the pop-up element is attached to the first greeting card panel and a portion of the pop-up element is attached to the second greeting card panel.

11. The greeting card with pop-up element of claim 7, wherein the pop-up element is not removable from the greeting card.

12. The greeting card with pop-up element of claim 7, wherein the fold line or perforated line does not intersect with the pop-up element.

13. The greeting card with pop-up element of claim 7, wherein the fold line or perforated line does not interact at all with the pop-up element.

14. The greeting card with pop-up element of claim 7, wherein the fold line or perforated line may have ornate segments.

15. A greeting card with pop-up element comprising:
a greeting card having a first panel and a second panel, the first and second panels separated by a vertical fold line, and an arced fold line which bifurcates the greeting card into an upper portion which lies above the arced fold line and a lower portion which lies beneath the arced fold line;
a pop-up structure which is attached to an inside surface of the greeting card, the pop-up structure operative to move between a first or closed position wherein the pop-up structure is collapsed or folded and a second position wherein the pop-up structure is upright or unfolded;
wherein the greeting card moves from a first or closed position, wherein the first panel of the greeting card is folded over the vertical fold line to lie atop the second panel of the greeting card and the pop-up structure is in a substantially flat position between the first and second greeting card panels, and a second or open position wherein the first panel is pivoted about the vertical fold line to lie in the same plane as the second panel and the pop-up structure is unfolded into a 3D structure;
wherein moving the greeting card between the first position to the second position and folding the greeting card in a downward direction along the arced fold line stabilizes and maintains the greeting card in the second position between a lower edge of the lower portion of the greeting card and the upper edge of the upper portion of the greeting card.

16. The greeting card with pop-up element of claim 15, wherein the arced fold line does not interact or interoperate with the pop-up structure.

17. The greeting card with pop-up element of claim 15, wherein the pop-up structure is attached to the upper portion of the greeting card.

18. The greeting card with pop-up element of claim 15, wherein the pop-up structure is not removable from the greeting card.

19. The greeting card with pop-up element of claim 15, wherein the arced fold line may have ornate segments.

20. The greeting card with pop-up element of claim 15, wherein a portion of the pop-up structure is attached to the first panel of the greeting card and a portion of the pop-up structure is attached to the second panel of the greeting card.
